(19) United States
(12) Patent Application Publication
(10) Pub. No.: US 2025/0326874 A1
(43) Pub. Date: Oct. 23, 2025

(54) ACTIVE ENERGY RAY-CURABLE COMPOSITION, AND CURED PRODUCT THEREOF

(71) Applicant: DIC Corporation, Tokyo (JP)

(72) Inventors: Yuki Kinoshita, Ichihara-shi (JP); Masakazu Yoshizawa, Ichihara-shi (JP); Dongmi Shin, Ichihara-shi (JP); Yutaro Ueda, Ichihara-shi (JP); Yasuhiro Takada, Ichihara-shi (JP); Yoshinobu Deguchi, Ichihara-shi (JP)

(73) Assignee: DIC Corporation, Tokyo (JP)

(21) Appl. No.: 18/873,067

(22) PCT Filed: Jun. 23, 2023
(86) PCT No.: PCT/JP2023/023342

§ 371 Date: Dec. 9, 2024

(30) Foreign Application Priority Data
Jun. 30, 2022 (JP) 2022-106541
Sep. 14, 2022 (JP) 2022-146130

(51) Int. Cl. C08F 220/30; C08F 2/44; C08F 2/50; C08F 120/18; C08F 120/30; C08F 220/18; C08K 3/22; C08K 9/06; G02B 1/04

(52) U.S. Cl. CPC C08F 220/301; C08F 2/44; C08F 2/50; C08F 120/18; C08F 120/30; C08F 220/1818; C08K 3/22; C08K 9/06; G02B 1/04; C08K 2003/2244

(57) ABSTRACT

The present invention can provide an active energy ray-curable composition with good mold releasability and with a high refractive index and a low viscosity and can also provide a cured product thereof. The active energy ray-curable composition of the present invention contains inorganic nanoparticles (A), a (meth)acrylate compound (B), and a photopolymerization initiator (C). The (meth)acrylate compound (B) contains a monofunctional (meth)acrylate (B1). The content of the monofunctional (meth)acrylate (B1) in the (meth)acrylate compound (B) is 70% by mass or more. The mass blending ratio [(A)/(B1)] of the monofunctional (meth)acrylate (B1) to the inorganic nanoparticles (A) is in a range of 0.5 to 3.

### TECHNICAL FIELD

The present invention relates to an active energy ray-curable composition and a cured product thereof.

The present application claims priority based on Japanese Patent Application No. 2022-106541 filed in Japan on Jun. 30, 2022 and Japanese Patent Application No. 2022-146130 filed in Japan on Sep. 14, 2022, which are hereby incorporated herein by reference.

### BACKGROUND ART

In recent years, optical sheets having functions of improving luminance, expanding viewing angles, and the like have been used in displays such as liquid crystal displays.

Such optical sheets usually have a base material and an optical functional layer having a fine uneven structure on the base material, and a desired function is expressed by modulating light in the uneven shape through geometric optical effects such as refraction. Since such an uneven shape is mainly produced by a method of molding a resin material using a mold, the material used for the optical functional layer is required to contain no solvents and have a low viscosity, and furthermore, the optical functional layer is required not to be damaged when being peeled off from the mold (during mold releasing) after curing.

Meanwhile, as displays become thinner and less power is consumed, a higher refractive index is required for the material used for the optical functional layer. To cope with this, methods that use a monofunctional (meth)acrylate with a high refractive index and a low viscosity or add organic or inorganic high refractive index fine particles have been developed (for example, PTL 1 to PTL 3).

### CITATION LIST

### Patent Literature

PTL 1: WO 2020/250721
PTL 2: Japanese Unexamined Patent Application Publication No. 2013-249439
PTL 3: Japanese Unexamined Patent Application Publication No. 2010-85539

### SUMMARY OF INVENTION

### Technical Problem

However, resins with a low content of a polyfunctional (meth)acrylate have fewer branches in their polymer structure after curing, thus unfortunately damage during mold releasing and resin remaining on the mold are likely to occur. Thus, a material with good mold releasability and with a high refractive index and a low viscosity has been demanded.

The present invention has been made in order to solve the above problem, and an object of the present invention is to provide an active energy ray-curable composition with good mold releasability and with a high refractive index and a low viscosity and to provide a cured product thereof.

### Solution to Problem

The present invention has found that making the content of a monofunctional (meth)acrylate in a (meth)acrylate compound a specific range and blending inorganic nanoparticles in a certain amount achieve a high refractive index and show good mold releasability and has thus been filed for a patent.

The contents of the present disclosure include the following embodiments:

[1] An active energy ray-curable composition containing:
inorganic nanoparticles (A);
a (meth)acrylate compound (B); and
a photopolymerization initiator (C),
the (meth)acrylate compound (B) containing a monofunctional (meth)acrylate (B1),
a content of the monofunctional (meth)acrylate (B1) in the (meth)acrylate compound (B) being 70% by mass or more, and
a mass blending ratio [(A)/(B1)] of the monofunctional (meth)acrylate (B1) to the inorganic nanoparticles (A) being in a range of 0.5 to 3.

[2] The active energy ray-curable composition according to [1], in which a content of the inorganic nanoparticles (A) in the active energy ray-curable composition is 30% by mass or more.

[3] The active energy ray-curable composition according to [1] or [2], in which the inorganic nanoparticles (A) are one or more selected from the group consisting of zirconia, silica, barium sulfate, zinc oxide, barium titanate, cerium oxide, and alumina and titanium oxide.

[4] The active energy ray-curable composition according to any one of [1] to [3], in which the (meth)acrylate compound (B) further contains a polyfunctional (meth)acrylate (B2), in which
a content of the monofunctional (meth)acrylate (B1) in the (meth)acrylate compound (B) is in a range of 70 to 90% by mass, and
a content of the polyfunctional (meth)acrylate (B2) in the (meth)acrylate compound (B) is in a range of 10 to 30% by mass.

[5] The active energy ray-curable composition according to any of [1] to [4], in which the monofunctional (meth)acrylate (B1) contains a compound containing two aromatic rings in one molecule.

[6] The active energy ray-curable composition according to [5], in which a content of the compound containing two aromatic rings in one molecule in the monofunctional (meth)acrylate (B1) is 50% by mass or more.

[7] The active energy ray-curable composition according to any of [1] to [6], further containing a dispersant (D), in which
the dispersant (D) contains a phosphate compound, and
the phosphate compound has at least one (meth)acryloyl group and at least one polyester chain.

[8] The active energy ray-curable composition according to any one of [1] to [7], in which the active energy ray-curable composition has a viscosity at 25° C. of 1,200 mPa-s or less.

[9]A cured product of the active energy ray-curable composition according to any one of [1] to [8].

[10] The cured product according to [9], in which the cured product has a refractive index (589 nm) at 25° C. of 1.65 or more.

[11] An optical sheet containing the cured product according to [9].

### Advantageous Effects of Invention

The present invention can provide an active energy ray-curable composition with good mold releasability and with a high refractive index and a low viscosity and can also provide a cured product thereof.

### DESCRIPTION OF EMBODIMENTS

The present invention will be described in more detail below. The present invention is not limited only to the embodiments shown below.

The “to” means the value before the description of “to” or more and the value after the description of “to” or less. “(Meth)acrylic” is a generic term for acrylic and methacrylic, and a “(meth)acrylate compound (B)” is a generic term for an acrylate compound and a methacrylate compound.

### (Active Energy Ray-Curable Composition)

An active energy ray-curable composition according to the present embodiment contains inorganic nanoparticles (A), a (meth)acrylate compound (B), and a photopolymerization initiator (C). The (meth)acrylate compound (B) contains a monofunctional (meth)acrylate (B1) in an amount of 70% by mass or more in the (meth)acrylate compound (B). The mass blending ratio [(A)/(B1)] of the monofunctional (meth)acrylate (B1) to the inorganic nanoparticles (A) is in a range of 0.5 to 3.

### [Inorganic Nanoparticles (A)]

The inorganic nanoparticles (A) according to the present embodiment are preferably one or more selected from the group consisting of zirconia, silica, barium sulfate, zinc oxide, barium titanate, cerium oxide, and alumina and titanium oxide.

The crystal structure of the inorganic nanoparticles (A) according to the present embodiment is also not limited to a particular crystal shape, and for example, when they are zirconia, the monoclinic crystal system is preferred because it has excellent dispersion stability and produces a cured product with a high light transmittance and a high refractive index.

For the inorganic nanoparticles (A) according to the present embodiment, normally known ones can be used, and the shape of the particles is not limited to a particular shape and may be, for example, any of spherical, hollow, porous, rod-shaped, plate-shaped, fibrous, and irregularly shaped. Among them, being spherical is preferred because it has excellent dispersion stability and produces a cured product with a high light transmittance and a high refractive index.

### <Zirconia Nanoparticles>

The inorganic nanoparticles (A) according to the present embodiment are preferably zirconia nanoparticles. For the zirconia nanoparticles, normally known ones can be used, and the shape of the particles is not limited to a particular shape, and examples thereof include spherical, hollow, porous, rod-shaped, and fibrous, and among these, being spherical is preferred.

The average primary particle size of the zirconia nanoparticles according to the present embodiment is preferably 1 to 50 nm and more preferably 1 to 30 nm. Furthermore, the crystal structure is not limited to a particular crystal structure, and the monoclinic system is preferred.

The average primary particle size in the present invention can be measured by a method using a transmission electron microscope (TEM) to directly measure the size of primary particles from an electron micrograph. Examples of the method of measurement include a method of measuring the short-axis size and the long-axis size of the primary particles of individual inorganic fine particles and regarding the average thereof as the average primary particle size of the primary particles.

Specific examples of the zirconia nanoparticles according to the present embodiment include UEP-100 (average primary particle size: 11 nm) manufactured by Daiichi Kigenso Kagaku Kogyo Co., Ltd. and PCS (average primary particle size: 20 nm) manufactured by Nippon Denko Co., Ltd.

The mass blending ratio [(A)/(B1)] of the monofunctional (meth)acrylate (B1) to the inorganic nanoparticles (A) is in a range of 0.5 to 3, preferably in a range of 0.7 to 2.5, more preferably in a range of 0.85 to 2, and even more preferably in a range of 1 to 1.5. By setting these ranges, both good mold releasability and a low viscosity can be achieved.

### [(Meth)acrylate Compound (B)]

The (meth)acrylate compound (B) according to the present embodiment is not limited to a particular (meth)acrylate compound so long as the (meth)acrylate compound (B) contains the monofunctional (meth)acrylate (B1) in an amount of 70 parts by mass or more, and examples thereof include the monofunctional (meth)acrylate (B1) and a polyfunctional (meth)acrylate (B2) having a (meth)acryloyl group and/or a (meth)acryloyloxy group for optical sheet formation, which are conventionally known. Oligomers, prepolymers, or the like can be used as needed. The (meth)acrylate compound (B) according to the present embodiment preferably contains the monofunctional (meth)acrylate (B1) having one active energy ray curable group (hereinafter may be simply referred to as the “(B1) component”) and the polyfunctional (meth)acrylate (B2) having two or more active energy ray curable groups (hereinafter may be simply referred to as the “(B2) component”). The active energy ray curable group is preferably a (meth)acryloyl group.

Note that the (meth)acrylate compound (B) according to the present embodiment shall not contain a dispersant (D) having a (meth)acryloyl group or a silane coupling agent (E) having a (meth)acryloyl group and/or a (meth)acryloyloxy group.

The following describes the (B1) and (B2) components in detail.

### <Monofunctional (Meth)acrylate (B1)>

The monofunctional (meth)acrylate (B1) is a monofunctional (meth)acrylate having one active energy ray curable group and may be a chain-like aliphatic, ring-like alicyclic, or aromatic (meth)acrylate containing a heteroatom such as a halogen atom, a sulfur atom, an oxygen atom, or a nitrogen atom, and the monofunctional (meth)acrylate described in PTL 1 described above can be used, for example.

Examples of the monofunctional (meth)acrylate (B1) include aromatic mono(meth)acrylate compounds, aliphatic mono(meth)acrylate compounds, alicyclic mono(meth)acrylate compounds, heterocyclic mono(meth)acrylate compounds, and hydroxy group-containing mono(meth)acrylate compounds.

Examples of the monofunctional (meth)acrylate (B1) include polyoxyalkylene-modified mono(meth)acrylate compounds in which a polyoxyalkylene chain such as a polyoxyethylene chain, a polyoxypropylene chain, or a polyoxytetramethylene chain is introduced into the molecular structure of the various mono(meth)acrylate compounds described above; and lactone-modified mono(meth)acrylate compounds in which a (poly)lactone-derived structure is introduced into the molecular structure of the various mono(meth)acrylate compounds described above.

Examples of the aromatic mono(meth)acrylate compounds include benzyl (meth)acrylate, phenyl (meth)acrylate, phenoxy (meth)acrylate, phenoxyethyl (meth)acrylate, phenoxyethoxyethyl (meth)acrylate, 2-hydroxy-3-phenoxypropyl (meth)acrylate, phenoxybenzyl (meth)acrylate, biphenylmethyl (meth)acrylate, benzylbenzyl (meth)acrylate, phenylphenoxyethyl (meth)acrylate, phenylphenol (EO)n (meth)acrylate, and phenol (EO)n (meth)acrylate.

Examples of the aliphatic mono(meth)acrylate compounds include methyl (meth)acrylate, ethyl (meth)acrylate, propyl (meth)acrylate, n-butyl (meth)acrylate, isobutyl (meth)acrylate, tert-butyl (meth)acrylate, n-pentyl (meth)acrylate, n-hexyl (meth)acrylate, n-octyl (meth)acrylate, isooctyl (meth)acrylate, and 2-ethylhexyl (meth)acrylate.

Examples of the alicyclic mono(meth)acrylate compounds include cyclohexyl (meth)acrylate, isobornyl (meth)acrylate, adamantyl mono(meth)acrylate, cyclohexylmethyl (meth)acrylate, cyclohexylethyl (meth)acrylate, dicyclopentanyl (meth)acrylate, dicyclopentanyloxyethyl (meth)acrylate, dicyclopentenyl (meth)acrylate, and dicyclopentenyloxyethyl (meth)acrylate.

Examples of the heterocyclic mono(meth)acrylate compounds include glycidyl (meth)acrylate and tetrahydrofurfuryl acrylate.

Examples of the hydroxy group-containing mono(meth)acrylate compounds include hydroxyethyl (meth)acrylate, hydroxypropyl (meth)acrylate, and hydroxybutyl (meth)acrylate.

Examples of the lactone-modified mono(meth)acrylate compounds include caprolactone-modified tetrahydrofurfuryl (meth)acrylate.

The monofunctional (meth)acrylate (B1) preferably contains an aromatic mono(meth)acrylate compound and more preferably contains a compound containing two aromatic rings in one molecule. The compound containing two aromatic rings in one molecule is particularly preferably biphenylmethyl (meth)acrylate.

Examples of the compound containing two aromatic rings in one molecule (the aromatic mono(meth)acrylate compound) include phenoxybenzyl (meth)acrylate, biphenylmethyl (meth)acrylate, benzylbenzyl (meth)acrylate, phenylphenoxyethyl (meth)acrylate, phenylphenol (EO)n (meth)acrylate, and (1-naphthyl)methyl acrylate.

Specific examples of the monofunctional (meth)acrylate (B1) include the following monofunctional (meth)acrylates used in examples.

Compound (B1-1): ortho-phenylphenol (EO) acrylate, trade name: KOMERATE A011 (manufactured by Green Chemical Co., Ltd.)

Compound (B1-2): biphenylmethyl acrylate, trade name: MIRAMER M1192 (manufactured by Miwon Specialty Chemical Co., Ltd.)

Compound (B1-3): 3-phenoxybenzyl acrylate, trade name: KOMERATE A008 (manufactured by Green Chemical Co., Ltd.)

Compound (B1-4): (1-naphthyl)methyl acrylate, trade name: Light Acrylate NMT-A (manufactured by Kyoeisha Chemical Co., Ltd.)

Compound (B1-5): phenoxyethyl acrylate, trade name: Photomer 4035 (manufactured by IGM Resins Inc.)

Compound (B1-6): benzyl acrylate, trade name: MIRAMER M1182 (manufactured by Miwon Specialty Chemical Co., Ltd.)

The monofunctional (meth)acrylate (B1) may be used alone or two or more may be used in combination.

The content of the monofunctional (meth)acrylate (B1) in the (meth)acrylate compound (B) is 70% by mass, preferably 75% by mass or more, more preferably 80% by mass or more, and even more preferably 85% by mass or more. The content of the monofunctional (meth)acrylate (B1) in the (meth)acrylate compound (B) is preferably 95% by mass or less and more preferably 90% by mass or less. This is because when the content of the monofunctional (meth)acrylate (B1) is in the above range, good mold releasability and a high refractive index and a low viscosity are provided.

When the monofunctional (meth)acrylate (B1) contains the compound containing two aromatic rings in one molecule (the aromatic mono(meth)acrylate compound), the content of the compound containing two aromatic rings in one molecule in the monofunctional (meth)acrylate (B1) is preferably 50% by mass or more, more preferably 60% by mass or more, and even more preferably 70% by mass or more. Examples of the compound having two aromatic rings in one molecule include biphenylmethyl (meth)acrylate. The content of the above compound is not limited to a particular content, and a higher value is more preferred. In particular, from the viewpoint of mold releasability, the content of the above compound is preferably 95% by mass or less and more preferably 90% by mass or less.

When the compound containing two aromatic rings in one molecule in the monofunctional (meth)acrylate (B1) is biphenylmethyl acrylate, it provides excellent base material adhesion in particular, in addition to refractive index, viscosity, and mold releasability.

### [Polyfunctional (Meth)acrylate (B2)]

The (meth)acrylate compound (B) according to the present embodiment preferably contains the polyfunctional (meth)acrylate (B2) (may be referred to as the “(B2) component”) apart from the monofunctional (meth)acrylate (B1) according to the present embodiment.

The polyfunctional (meth)acrylate (B2) is preferably a polyfunctional (meth)acrylate having three or more active energy ray curable groups. The polyfunctional (meth)acrylate (B2) may be a chain-like aliphatic, ring-like alicyclic, or aromatic (meth)acrylate containing a heteroatom such as a halogen atom, a sulfur atom, an oxygen atom, or a nitrogen atom, and the polyfunctional (meth)acrylate described in PTL 1 described above can be used, for example.

Examples of the polyfunctional (meth)acrylate (B2) include the polyfunctional (meth)acrylate (B2) such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, butylene glycol di(meth)acrylate, tetrabutylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dicyclopentanyl di(meth)acrylate, glycerol di(meth)acrylate, neopentyl glycol hydroxypivalate di(meth)acrylate, caprolactone-modified hydroxypivalate neopentyl glycol di(meth)acrylate, tetrabromobisphenol A di(meth)acrylate, hydroxypivalaldehyde-modified trimethylolpropane di(meth)acrylate, bisphenol fluorene di (meth)acrylate, bisphenol fluorene (EO)ₙ di(meth)acrylate, bisphenol A (EO)n di(meth)acrylate, trimethylolpropane (EO)n tri(meth)acrylate, 1,4-cyclohexanedimethanol di(meth)acrylate, trimethylolpropane tri(meth)acrylate, pentaerythritol tri(meth)acrylate, glycerol tri(meth)acrylate, tri(meth)acrylate of alkyl-modified dipentaerythritol, pentaerythritol tetraacrylate, ditrimethylolpropane tetra(meth)acrylate, epoxy (meth)acrylate, urethane (meth)acrylate, and polyester (meth)acrylate.

These polyfunctional (meth)acrylates (B2) can be used alone or two or more can be used in combination. Among these, preferred are trimethylolpropane tri(meth)acrylate, ethoxylated trimethylolpropane tri(meth)acrylate, ditrimethylolpropane tetra(meth)acrylate, reaction products of pentaerythritol and acrylic acid, reaction products of dipentaerythritol and acrylic acid, and the like because they produce (meth)acrylic resins with excellent drying properties, ink fluidity, and high-speed printing suitability.

One example of the polyfunctional (meth)acrylate (B2) according to the present embodiment is a mixture of a polyfunctional (meth)acrylate having three active energy ray curable groups and a polyfunctional (meth)acrylate having four active energy ray curable groups. Specific examples thereof include mixtures of pentaerythritol triacrylate and pentaerythritol tetraacrylate (containing about 30 to 70% by mass of the tri-body and about 70 to 30% by mass of the tetra-body therein). Examples of the mixtures include “Aronix M-305” (manufactured by Toagosei Co., Ltd., a reaction product of pentaerythritol and acrylic acid, containing about 60% of the tri-body, hydroxy group value: 116 mgKOH/g) used in one of the examples.

When the content of the monofunctional (meth)acrylate (B1) in the (meth)acrylate compound (B) is in a range of 70 to 90% by mass, the content of the polyfunctional (meth)acrylate (B2) in the (meth)acrylate compound (B) according to the present embodiment is preferably in a range of 10 to 30% by mass, more preferably 10 to 25% by mass, and even more preferably 10 to 20% by mass. When the content of the polyfunctional (meth)acrylate (B2) in the (meth)acrylate compound (B) is within this range, it provides an excellent refractive index.

### [Photopolymerization Initiator (C)]

The photopolymerization initiator (C) according to the present embodiment is not limited to a particular photopolymerization initiator so long as it has a function of being able to initiate polymerization of the (meth)acryloyl group of the (meth)acrylate compound (B) or the like according to the present embodiment by photoexcitation, and examples thereof include an intramolecular bond cleavage type photopolymerization initiator (C) and an intramolecular hydrogen abstraction type photopolymerization initiator (C). For example, monocarbonyl compounds, dicarbonyl compounds, acetophenone compounds, benzoyl ether compounds, acylphosphine oxide compounds, aminocarbonyl compounds, and the like can be used.

Examples of the intramolecular bond cleavage type photopolymerization initiator (C) include acetophenone-based ones such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl-phenyl ketone, 2-methyl-2-morpholino(4-thiomethylphenyl)propan-1-one, and 2-benzyl-2-dimethylamino-1-(4-morpholinophenyl)-butanone; benzoins such as benzoin, benzoin methyl ether, and benzoin isopropyl ether; acylphosphine oxide-based ones such as 2,4,6-trimethylbenzoin diphenylphosphine oxide; and benzil and methyl phenyl glyoxy ester.

Examples of the intramolecular hydrogen abstraction type photopolymerization initiator (C) include benzophenone-based ones such as benzophenone, methyl o-benzoylbenzoate-4-phenylbenzophenone, 4,4′-dichlorobenzophenone, hydroxybenzophenone, 4-benzoyl-4′-methyl-diphenyl sulfide, acrylated benzophenone, 3,3′,4,4′-tetra(t-butylperoxycarbonyl)benzophenone, and 3,3′-dimethyl-4-methoxybenzophenone; thioxanthone-based ones such as 2-isopropylthioxanthone, 2,4-dimethylthioxanthone, 2,4-diethylthioxanthone, and 2,4-dichlorothioxanthone; aminobenzophenone-based ones such as Michler's ketone and 4,4′-diethylaminobenzophenone; and 10-butyl-2-chloroacridone, 2-ethylanthraquinone, 9,10-phenanthrenequinone, and camphorquinone.

The photopolymerization initiator (C) is preferably 2,4,6-trimethylbenzoyl diphenylphosphine oxide.

Examples of commercially available products of the photopolymerization initiator (C) include Omnirad-184, 651, 500, 907, 127, 369, 784, and 2959 and TPO-H manufactured by IGM Resins and Esacure ONE manufactured by DKSH Japan Co., Ltd.

Omnirad-907 and Omnirad-TPO-H are preferred from the viewpoint of obtaining a cured coating film with excellent curability even when added in a small amount. Omnirad-184 is particularly preferred from the viewpoint of low coloration.

The photopolymerization initiator (C) is not limited to the above compounds and can be any one so long as it has the ability to initiate polymerization through ultraviolet rays. These photopolymerization initiators (C) may be used alone or two more may be used mixed together.

The use amount of the photopolymerization initiator (C) is not limited to a particular amount, and it is preferably used within a range of 0.1 to 10 parts by mass and more preferably used within a range of 1 to 5 parts by mass with respect to 100 parts by mass of a total non-volatile content of the active energy ray-curable composition of the present embodiment. Known organic amines or the like can also be added as sensitizers.

Furthermore, apart from the initiator for radical polymerization, an initiator for cationic polymerization can also be used in combination.

Specific examples of the photopolymerization initiator (C) according to the present embodiment include Runtecure 1108 (manufactured by Runtec Chemical Co., Ltd., structural formula or compound name: 2,4,6-trimethylbenzoyl diphenylphosphine oxide).

The content of the photopolymerization initiator (C) is preferably 0.1 to 10% by mass and more preferably 0.5 to 5% by mass with respect to the mass of the non-volatile content of the composition.

The mass of the non-volatile content of the composition is the total mass of all the components of the composition after excluding solvents contained in the composition.

### [Dispersant (D)]

The active energy ray-curable composition of the present embodiment preferably further contains a dispersant (D) (may be referred to as the “(D) component”), and the dispersant (D) more preferably contains a phosphate.

### <Phosphate>

The phosphate according to the present embodiment is not limited to a particular phosphate, and examples thereof include ones having a polyester chain and ones having a (meth)acryloyl group.

Examples of ones having a polyester chain include DISPERBYK-110 and DISPERBYK-111 (manufactured by BYK-Chemie Japan K.K.)

Examples of ones having a (meth)acryloyl group include one represented by Structural Formula (1) below. This case is preferred because an inorganic particles dispersion to be obtained has excellent dispersion stability, and a curable composition containing it has a low viscosity and can form a cured coating film having high refractive index performance and excellent bleed-out resistance.

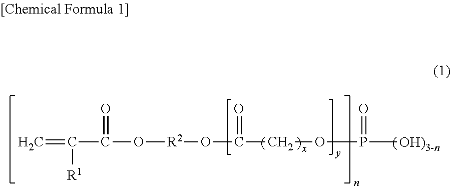

wherein R¹ is a hydrogen atom or a methyl group; R² is a C₂₋₄ alkylene chain; x is an integer of 4 to 10; y is an integer of 1 or more; and n is an integer of 1 to 3.

For the phosphate compound represented by Structural Formula (1) above, x in the formula is preferably 4 or 5, and y is preferably an integer of 2 to 7. This is because the active energy ray-curable composition to be obtained has a low viscosity and can form a cured coating film having high refractive index performance and excellent bleed-out resistance. The dispersant (D) represented by Structural Formula (1) above may be a mixture of n in the formula being 1, 2 and/or 3.

The content of the phosphate compound in the active energy ray-curable composition is more preferably in a range of 5 to 40 parts by mass and even more preferably in a range of 10 to 25 parts by mass with respect to 100 parts by mass of zirconia because a cured coating film having high refractive index performance and excellent bleed-out resistance can be formed.

### [Silane Coupling Agent (E)]

The active energy ray-curable composition of the present embodiment may further contain a silane coupling agent (E) (may be referred to as the “(E) component”). Examples of the silane coupling agent (E) according to the present embodiment include (meth)acryloyloxy-based silane coupling agents such as 3-(meth)acryloyloxypropyltrimethylsilane, 3-(meth)acryloyloxypropylmethyldimethoxysilane, 3-(meth)acryloyloxypropyltrimethoxysilane, 3-(meth)acryloyloxypropylmethyldiethoxysilane, and 3-(meth)acryloyloxypropyltriethoxysilane;
vinyl-based silane coupling agents such as allyltrichlorosilane, allyltriethoxysilane, allyltrimethoxysilane, diethoxymethylvinylsilane, trichlorovinylsilane, vinyltrichlorosilane, vinyltrimethoxysilane, vinyltriethoxysilane, and vinyltris(2-methoxyethoxy)silane;
epoxy-based silane coupling agents such as diethoxy(glycidyloxypropyl)methylsilane, 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane;
styrene-based silane coupling agents such as p-styryltrimethoxysilane;
amino-based silane coupling agents such as N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane;
ureido-based silane coupling agents such as 3-ureidopropyltriethoxysilane;
chloropropyl-based silane coupling agents such as 3-chloropropyltrimethoxysilane; mercapto-based silane coupling agents such as 3-mercaptopropylmethyldimethoxysilane and 3-mercaptopropyltrimethoxysilane;
sulfide-based silane coupling agents such as bis(triethoxysilylpropyl)tetrasulfide;
isocyanate-based silane coupling agents such as 3-isocyanate propyltriethoxysilane; and
aluminum-based silane coupling agents such as acetoalkoxyaluminum diisopropylate.

These silane coupling agents (E) can be used alone or two or more can be used in combination. Among these, 3-(meth)acryloyloxypropyltrimethoxysilane is preferred because of its good compatibility with the acrylate compound (B).

The use amount of the silane coupling agent (E) according to the present embodiment is preferably in a range of 10 to 30 parts by mass with respect to 100 parts by mass of zirconia. This is because the active energy ray-curable composition to be obtained has excellent dispersion stability and because it has a low viscosity and a cured coating film having high refractive index performance and excellent bleed-out resistance can be formed.

### [Solvent]

The active energy ray-curable composition of the present embodiment may contain a solvent.

The solvent is not limited to a particular solvent, and various known organic solvents can be used. Specific examples thereof include cyclohexanone, methyl isobutyl ketone, methyl ethyl ketone, acetone, acetyl acetone, toluene, xylene, n-butanol, isobutanol, tert-butanol, n-propanol, isopropanol, ethanol, methanol, 3-methoxy-1-butanol, 3-methoxy-2-butanol, ethylene glycol monomethyl ether, ethylene glycol mono-n-butyl ether, 2-ethoxyethanol, 1-methoxy-2-propanol, diacetone alcohol, ethyl lactate, butyl lactate, propylene glycol monomethyl ether, ethylene glycol monobutyl ether acetate, propylene glycol monomethyl ether acetate, 2-ethoxyethyl acetate, butyl acetate, isoamyl acetate, dimethyl adipate, dimethyl succinate, dimethyl glutarate, tetrahydrofuran, and methyl pyrrolidone. Among these, methyl ethyl ketone is preferred. Two or more of these organic solvents may be used in combination.

The active energy ray-curable composition of the present embodiment can contain, for example, a solvent used in synthesizing each resin.

For the active energy ray-curable composition of the present embodiment, the inorganic particles (A), the solvent, and optional components may be mixed together to prepare an inorganic nanoparticles (A) dispersion, which may be mixed with the (meth)acrylate compound (B) and the photopolymerization initiator (C).

The above example containing the solvent is an example, and even if the solvent is contained in the process of preparing the active energy ray-curable composition of the present embodiment, the solvent is preferably volatilized in the end, and the content of the solvent is preferably as low as possible. Thus, when the active energy ray-curable composition of the present embodiment contains the solvent, the content of the solvent in the active energy ray-curable composition is preferably 0 to 5% by mass and more preferably 0 to 0.1% by mass.

### [Viscosity of Active Energy Ray-Curable Composition]

The viscosity of the active energy ray-curable composition of the present embodiment at 25° C. is preferably 6,500 Pa-s or less, and the viscosity at 25° C. is more preferably 3,500 mPa s or less, and even more preferably 1,500 mPa s or less. In addition, the viscosity at 25° C. is preferably 1,000 mPa s or less. Within that range, application suitability is provided.

### [Method for Preparing Active Energy Ray-Curable Composition]

The method for preparing the active energy ray-curable composition of the present embodiment is not limited to a particular method. Examples thereof include a method of production by obtaining a dispersion of the inorganic nanoparticles (A) and then mixing together the dispersion of the inorganic nanoparticles (A), the monofunctional (meth)acrylate (B1), the photopolymerization initiator, and, as needed, the polyfunctional (meth)acrylate (B2) and various other additives.

The method for producing the active energy ray-curable composition of the present embodiment preferably includes a step of preparing the inorganic nanoparticles (A) dispersion; and a step of mixing together the inorganic nanoparticles (A) dispersion, the monofunctional (meth)acrylate (B1), the photopolymerization initiator, and, as needed, the polyfunctional (meth)acrylate (B2) and various other additives.

The method of mixing is not limited to a particular method, and examples thereof include a method using a media type wet dispersing machine.

In the step of preparing the inorganic nanoparticles (A) dispersion, at least part of the monofunctional (meth)acrylate (B1) or, as needed, at least part of the polyfunctional (meth)acrylate (B2) may be added.

### <Inorganic Nanoparticles (A) Dispersion>

The inorganic nanoparticles (A) dispersion according to the present embodiment preferably contains, for example, the inorganic nanoparticles (A), the solvent, and the dispersant (D) as the additive. The inorganic nanoparticles (A) dispersion according to the present embodiment may further contain at least part of the monofunctional (meth)acrylate (B1) or, as needed, at least part of the polyfunctional (meth)acrylate (B2).

The dispersant (D) preferably has an acid value in a range of 50 to 300 mgKOH/g. The dispersant (D) in general is likely to cause flocculation of the inorganic nanoparticles in the system due to the interaction or the like of the inorganic nanoparticles (A) with other resin components contained in the active energy ray-curable composition of the present embodiment, and the stability of the active energy ray-curable composition reduces during storage or the transparency of the cured coating film reduces. By using the dispersant (D) with an acid value in a range of 50 to 300 mgKOH/g, a curable composition with excellent stability over time can be obtained, and the cured product will have not only a high refractive index but also excellent light transmission properties and scratch resistance.

The inorganic nanoparticles (A) dispersion according to the present embodiment more preferably further contains the silane coupling agent (E) as the additive. Functional groups can be introduced to the surface of the inorganic nanoparticles (A) using the various silane coupling agents (E) and the like described above.

The method for producing the inorganic nanoparticles (A) dispersion according to the present embodiment is not limited to a particular method, and examples thereof include a method of production by a method of dispersing raw materials containing the inorganic nanoparticles (A), the dispersant (D), and, as needed, the silane coupling agent (E) with a media type wet dispersing machine.

For the media type wet dispersing machine used in the above method of production, normally known ones can be used without limitations, and examples thereof include bead mills (such as Star Mill LMZ-015 manufactured by Ashizawa Finetech Ltd. and Ultra Apex Mill UAM-015 manufactured by Kotobuki Industries Co., Ltd.).

The media used in the dispersing machine is not limited to particular media so long as they are normally known beads, and preferred examples thereof include zirconia, alumina, silica, glass, silicon carbide, and silicon nitride. The average particle size of the media is preferably 50 to 500 μm, with 50 to 200 μm media being more preferred. When the particle size is 50 μm or more, impact force on raw material powder is appropriate, and excessive time is not required for dispersion. On the other hand, when the particle size of the media is 500 μm or less, the impact force on the raw material powder is appropriate, which can prevent an increase in the surface energy of the dispersed particles and prevent re-flocculation.

The time for the step of dispersion can be shortened by a two-step method in which large-diameter media, which have large impact force, are used in the initial stage of pulverizing the raw material powder, and after the particle size of the dispersed particles has reduced, small-diameter media, which are less likely to re-flocculate, are used.

For the media, sufficiently polished media are desirably used from the viewpoint of inhibiting a reduction in the light transmittance of the dispersion to be obtained.

In the method of production using the media type wet dispersing machine, the order of charging each raw material into the dispersing machine is not limited to a particular order, and by at least supplying the dispersant (D) last, a curable composition with excellent dispersion stability can be obtained with the use of a small amount of the dispersant (D). More specifically, examples include a method of charging the raw materials other than the dispersant (D) first, performing work such as mixing or pre-dispersion, and then charging the dispersant (D) last to perform a step of full dispersion.

After the end of dispersion, various additives are added in accordance with uses or volatile components are distilled off, and the curable composition of the present invention can be obtained.

The particle size (which shall be the average particle size) of the inorganic nanoparticles (A) in the inorganic nanoparticles (A) dispersion is larger than the average primary particle size of the inorganic nanoparticles (A), which are one of the raw materials of the inorganic nanoparticles (A) dispersion, because some of the inorganic nanoparticles (A) flocculate in the dispersion.

Thus, the average particle size of the inorganic nanoparticles (A) in the inorganic nanoparticles (A) dispersion is preferably 100 nm or less and more preferably in a range of 20 to 100 nm because the cured product has a high refractive index and excellent light transmission properties as well.

### [Characteristics of Active Energy Ray-Curable Composition]

The active energy ray-curable composition of the present embodiment has good mold releasability and has a high refractive index and a low viscosity. Examples of the active energy ray-curable composition of the present embodiment include LUXYDIR (registered trademark) (manufactured by DIC Corporation).

### (Cured Product)

A cured product of the present embodiment is a cured product of the active energy ray-curable composition of the present embodiment described above. The cured product of the present embodiment can be used for various uses such as optical lenses, optical films, antireflection materials, thin film sealing materials, gluing agents for optical use, adhesives for optical use, and diffusion microlenses.

The shape of the cured product of the present embodiment is not limited to a particular shape and can be selected in accordance with uses, such as a flat sheet shape having a smooth face, a sheet shape having a fine uneven structure, or a sheet shape having a curved surface like a concave lens or a convex lens.

The cured product of the present embodiment has a refractive index (589 nm) at 25° C. of preferably 1.62 or more, more preferably 1.65 or more, and even more preferably 1.66 or more. This is to enable thinner films when used for optical lenses, to reduce a refractive index difference with a transparent electrode to make the transparent electrode less conspicuous in optical films, to impart an antireflective function by being combined with a low refractive index layer, and to increase light extraction efficiency from a light-emitting element part in LED sealing materials, for example. The upper limit of the refractive index is not limited to a particular value, and a higher value is more preferred. If it has to be limited, the upper limit of the refractive index is preferably 1.62 or more and 1.70 or less and more preferably 1.65 or more and 1.69 or less from the viewpoint of balance with viscosity.

### [Method for Producing Cured Product]

The method for producing the cured product of the present embodiment is not limited to a particular method and includes, for example, an application step of applying the active energy ray-curable composition of the present embodiment described above onto a base material such as a transparent film and a curing step of applying active energy rays to a film of the active energy ray-curable composition obtained in the application step to cure the film.

As the method of application to the base material such as a transparent film, known methods can be used, and for example, methods using a rod, a wire bar, or the like and various methods of coating such as microgravure, gravure, die, curtain, lip, slot, and spin can be used.

For the active energy rays, active energy rays can be used without particular limitations so long as they cause curing of the curable composition of the present invention, and use of ultraviolet rays is particularly preferred.

Examples of sources of ultraviolet rays include fluorescent chemical lamps, black lights, low-pressure, high-pressure, and ultrahigh-pressure mercury lamps, metal halide lamps, and sunlight. For example, an 80 W high-pressure mercury lamp can be used.

The application intensity of ultraviolet rays may be constant intensity from beginning to end, or the physical properties after curing can be fine-tuned by changing the intensity during curing. For example, when an 80 W high-pressure mercury lamp is used in a nitrogen atmosphere, ultraviolet rays can be applied with an energy value of 0.5 to 3.0 kJ/m².

Apart from ultraviolet rays, for example, active energy rays of visible rays and electron beams can also be used as the active energy rays.

### (Optical Sheet)

An optical sheet of the present embodiment can be formed using the cured product of the present embodiment. The optical sheet of the present embodiment may include, for example, a base material and the cured product according to the present embodiment formed on the base material.

The optical sheet of the present embodiment may have, for example, a fine pattern layer such as a fine uneven structure, which is a cured product of the active energy ray-curable composition of the present embodiment, and a transparent base material. The fine pattern layer such as the fine uneven structure may have, for example, a fine uneven structure of 10 to 500 μm on its surface in accordance with the use of the optical sheet.

The cured product of the active energy ray-curable composition in the optical sheet of the present embodiment may have a smooth face, not having the fine uneven structure. The shape can be selected as appropriate in accordance with various uses.

Examples of the optical sheet include polarizing films, retardation films, antireflection films, luminance enhancement films (prism sheets, micro lens sheets, and the like), light diffusion films, and hard coat films.

### [Base Material]

Examples of the base material according to the present embodiment include polyethylene terephthalate (PET), triacetyl cellulose (TAC), cyclo olefin polymers (COPs), cyclo olefin copolymers (COCs), polycarbonate, vinyl chloride, polymethacrylic imide, polyimide, polyester, polymethyl methacrylate (PMMA)-based acrylic base materials, glass, and silicon wafers.

The film thickness of the base material according to the present embodiment is preferably 1 to 300 μm and more preferably 5 to 100.

Specific examples of the base material according to the present embodiment include a 125 μm polyethylene terephthalate (PET) base material (trade name: A4300, manufactured by Toyobo Co., Ltd.) used in the examples.

When the base material is transparent, transparent base materials used for conventionally known optical sheets such as prism sheets can be used. For the transparent base material, for example, those described in PTL 2 can be used.

The transparent base material may be a resin base material or a glass base material.

Preferred transparent resin base materials are acrylic resins, polycarbonate resins, vinyl chloride resins, polymethacrylic imide resins, polyimide resins, polyester resins, cyclo olefin polymer (COP) resins and cyclo olefin copolymer (COC) resins, cellulose triacetate (TAC) resins, and the like.

The transparent base material may have a long shape or have a single leaf shape of a certain size.

The thickness of the transparent base material is normally preferably 50 to 500 μm, but this is not limiting.

The light transmittance of the transparent base material, for installation on the front of displays, is ideally 100%, and a transmittance of 85% or more is preferred.

The transparent base material may be subjected to conventionally known matte treatment (formation of light-diffusing fine unevenness), antistatic treatment, antireflection treatment, or the like on its surface as needed. In addition, matte treatment, antistatic treatment, or antireflection treatment may be applied to between the transparent resin and the base material, or any combination of these may be used.

### [Method for Producing Optical Sheet]

The method for producing the optical sheet of the present embodiment is not limited to a particular method and includes, for example, a step of applying the active energy ray-curable composition of the present embodiment described above to the base material and a step of applying active energy rays such as ultraviolet rays to form a cured coating film. The method for producing the stacked body of the present embodiment preferably includes, for example, a step of applying the active energy ray-curable composition of the present embodiment described above to a triacetyl cellulose base material film (a TAC base material film) with a thickness of 40 to 100 μm and a step of applying ultraviolet rays at 0.5 to 3.0 kJ/m² with a 60 to 100 W high-pressure mercury lamp in a nitrogen atmosphere to form a cured coating film with a film thickness of 5 to 20 μm on the TAC base material film.

As the method for producing the optical sheet of the present embodiment, for example, as illustrated in FIG. 2 of PTL (Japanese Unexamined Patent Application Publication No. 2009-37204), the above composition is placed in a mold with a desired fine pattern shape such as a fine uneven structure, a transparent base material layer is laid thereon, the transparent base material layer is compression bonded to the composition using a laminator or the like, and the composition is cured with ultraviolet rays or the like to form a fine pattern shape such as a fine uneven structure. Next, by peeling off or removing the mold with the fine pattern shape, an optical sheet including an optical function expressing part having the desired fine pattern shape on the transparent base material layer is obtained.

### <Prism Sheet>

Specific examples of the optical sheet of the present embodiment include a prism sheet. The prism sheet has, for example, a fine uneven structure layer, which is a cured product of the active energy ray-curable composition of the present embodiment, and a transparent base material. The fine uneven structure layer has a fine uneven structure with a period P of 10 to 100 μm on its surface. The thickness of the fine uneven structure layer is, for example, 5 μm to 100 μm.

Normally, when the content of the monofunctional (meth)acrylate (B1) in the composition is high, the cured product tends to have bad mold releasability because the polymer structure after curing has fewer branches. Focusing on this trend, the present invention has improved mold releasability by determining the mass blending ratio [(A)/(B1)] of the monofunctional (meth)acrylate (B1) to the inorganic nanoparticles (A) to be in a range of 0.5 to 3. More specifically, it is considered that when [(A)/(B1)] is in a range of 0.5 to 3, the inorganic nanoparticles (A) are easily present on the surface when the composition is applied to the base material (that is, near the interface between the composition and the mold), and the adhesion of the cured product of the composition to the mold has been able to be reduced.

Furthermore, the mold releasability of the cured product has been able to be further improved when the composition contains a silane coupling agent and a phosphate-based dispersant containing a (meth)acryloyl group. Concerning this, it is considered that the inorganic nanoparticles (A) compatibilize with the components other than (A) in the composition via the silane coupling agent and the phosphate-based dispersant, thereby increasing the strength of the cured product and making it hard for the cured product to remain on the mold during separation between the cured product and the mold.

In addition, in the present invention, the base material adhesion particularly improved when ortho-phenylphenol (EO) acrylate, biphenylmethyl acrylate, and (1-naphthyl)methyl acrylate were used as the monofunctional (meth)acrylate (B1). These compounds are monomers with relatively high glass transition temperatures and are considered to also improve the coating film hardness of the composition. This increase in hardness and a plurality of other factors may have combined to improve the base material adhesion.

In addition, when phenoxyethyl acrylate was used as the monofunctional (meth)acrylate (B1) too, the base material adhesion was good. It is considered that this is because interaction with the base material increases by phenoxyethyl acrylate containing a highly polar ethylene oxide structure in its molecule.

As described above, the configurations that can more produce the effects and the mechanisms considered to exhibit the effects have been described, but the present invention is not limited to these configurations, and the composition that does not contain the silane coupling agent or the phosphate-based dispersant or the composition that does not contain any specific compound as the monofunctional (meth)acrylate (B1) can also solve the problem of the present invention.

### EXAMPLES

The following describes the present invention in more detail by way of examples, but the present invention is not limited thereby.

### (Raw Materials)

Zirconia (A): UEP-100 (manufactured by Daiichi Kigenso Kagaku Kogyo Co., Ltd.)

“Dispersant (D)” (a phosphate compound): Dispersant D-1 (a compound represented by Structural Formula (1) below)

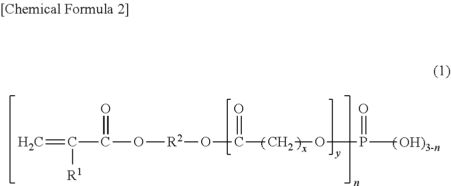

In the formula R¹ is a methyl group; R² is a C₂ ethylene chain; x is 5; y is 2 (an average); and n is an integer of 1 to 3.

“Silane coupling agent (E)”: KBM-503 (manufactured by Shin-Etsu Chemical Co., Ltd., 3-(trimethoxysilyl)propyl methacrylate)

“Monofunctional (meth)acrylate compound (B1)”: Ortho-phenylphenol (EO) acrylate, trade name: KOMERATE A011 (manufactured by Green Chemical Co., Ltd.)

Biphenylmethyl acrylate, trade name: MIRAMER M1192 (manufactured by Miwon Specialty Chemical Co., Ltd.)

3-Phenoxybenzyl acrylate, trade name: KOMERATE A008 manufactured by Green Chemical Co. Ltd.)

(1-Naphthyl)methyl acrylate, trade name: Light Acrylate NMT-A (manufactured by Kyoeisha Chemical Co., Ltd.)

Phenoxyethyl acrylate, trade name: Photomer 4035 (manufactured by IGM Resins Inc.)

Benzyl acrylate, trade name: MIRAMER M1182 (manufactured by Miwon Specialty Chemical Co., Ltd.)

“Polyfunctional (meth)acrylate compound (B2)”

A mixture of pentaerythritol triacrylate and pentaerythritol tetraacrylate (containing about 60% of the tri-body), trade name: Aronix M305 (manufactured by Toagosei Co., Ltd.)

“Photopolymerization initiator (C)”: 2,4,6-trimethylbenzoyl diphenylphosphine oxide, trade name: Runtecure 1108 (manufactured by Runtec Chemical Co., Ltd.)

### <Liquid Refractive Index>

The active energy ray-curable composition was applied directly to the prism of an Abbe refractometer and was measured at 25° C. Measurement wavelength: 589 nm.

### <Film Refractive Index>

The active energy ray-curable composition was placed between a glass plate and a transparent, easy adhesion-treated PET film (trade name: A4300, thickness: 125 μm, manufactured by Toyobo Co., Ltd.) as a transparent base material and was pressed and spread so as to have a film thickness of about 10 μm with a rubber hand roller. Subsequently, active energy rays were applied thereto to cure it. Next, the PET film was peeled off from the glass plate together with an active energy ray cured resin layer to form a cured coating film of the curable composition on the surface of the base material. The refractive index of the coating film was measured using PRISM COUPLER MODEL 2010/M (manufactured by Metricon Corporation).

“Application conditions”
Light source: ultraviolet rays of an ultrahigh-pressure mercury lamp
Accumulated light amount: 400 mJ/cm²
   “Measurement conditions”
Wavelength: 594 nm
Measurement mode: single film

### <Viscosity>

For the evaluation of viscosity, viscosity at a temperature of 25° C. was measured using an E-type rotational viscometer (“TVE-25H” manufactured by Toki Sangyo Co., Ltd.)

### <Mold Releasability>

The active energy ray-curable composition was filled between a mold formed of phosphor nickel and a PET film (trade name: A4300, thickness: 125 μm, manufactured by Toyobo Co., Ltd.) and was then cured by applying ultraviolet rays at 400 mJ/cm² with an ultrahigh-pressure mercury lamp from the PET film side. The mold formed of phosphor nickel was formed with an uneven shape with a linear array of unit prisms (pitch: 50 μm, height: 25 μm). The PET film was transparent and easy adhesion-treated as a transparent base material. Next, the PET film was peeled off from the mold together with a resin layer containing the active energy ray-curable composition to produce a cured product with a PET film shape with a required shape transferred. The area of the resin layer remaining on the mold at the time of this peeling was visually evaluated and determined as follows:
⊚: No resin layer remains on the mold.
O: Part of the resin layer remains on the mold.
X: The entire face remains on the mold.

### <Base Material Adhesion>

Adhesion was evaluated by a grid testing method using a cured product with a PET film shape obtained in the same manner as in the above method for evaluating <Mold Releasability>.

On a test face, 11 cuts reaching the substrate were made at 1 mm intervals using a cutter knife and a cutter guide to create 100 grid marks. Next, Cellotape (registered trademark) was strongly compression bonded to the grid part, the tape edge was pulled off at once, and the number of grids with no peeling in the resin layer was counted and determined.

### Example 1

UEP-100 in an amount of 45.00 parts by mass as zirconia,
6.75 parts by mass of Phosphate 1 (Dispersant D-1) as a phosphate,
4.50 parts by mass of KBM-503 as Silane coupling agent (1), and
96.8 parts by mass of methyl ethyl ketone (hereinafter abbreviated as “MEK”)
were mixed together and stirred with a dispersing stirrer for 30 minutes to perform coarse dispersion. Next, the obtained mixed liquid was subjected to dispersion treatment with a media type wet dispersing machine (“Star Mill LMZ-015” manufactured by Ashizawa Finetech Ltd.) using zirconia beads with a particle size of 100 μm. While checking the particle size during the process, dispersion treatment with a residence time of 100 minutes was performed to obtain an inorganic particles dispersion.

To this inorganic particles dispersion,

37.25 parts by mass of Compound (B1-2): MIRAMER M1192 (manufactured by Miwon Specialty Chemical Co., Ltd.) as the monofunctional (meth)acrylate (B1) and 5.00 parts by mass of Compound (B2-1): Aronix M305 (manufactured by Toagosei Co., Ltd.) as the polyfunctional (meth)acrylate compound (B2) were added, and volatile components were removed under reduced pressure while heating with an evaporator. Furthermore,
as a photopolymerization initiator, 0.7 part by mass of Runtecure 1108 (manufactured by Runtec Chemical Co., Ltd.)
was added to prepare active energy ray-curable composition P1 (Composition P1) of the present embodiment. The liquid refractive index and the viscosity of Composition P1 were evaluated using the above methods of evaluation. In addition, the film refractive index, the mold releasability, and the base material adhesion of a cured product of Composition P1 were evaluated. Table 1 lists those results.

### Examples 2 to 14 and Comparative Examples 1 to 6

For the examples, Compositions P2 to P14 and cP1 to cP6 of Examples 2 to 14 and Comparative Examples 1 to 6, respectively, were prepared in the same manner as in Example 1 except that the components and the composition ratios listed in Table 1 were used. The use amount of MEK was 2.15 times the blending amount of the inorganic nanoparticles listed in Table 1, as in Example 1. As in Example 1, the liquid refractive index, the film refractive index, and the viscosity of the compositions were evaluated. In addition, the mold releasability and the base material adhesion of the cured products of the compositions were evaluated. Table 1 lists those results.

TABLE 1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Active energy ray curable composition No. | | | P1 | P2 | P3 | P4 | P5 | P6 | P | P8 | P9 | P10 | P11 |
| Inorganic nanoparticles dispersion | Inorganic | Inorganic | 45.00 | 48.00 | 45.00 | 48.00 | 40.00 | 40.00 | 40.00 | 30.00 | 50.00 | 50.00 | 50.00 |
| (parts by mass) | nanoparticles | nanoparticles | | | | | | | | | | | |
| | (A) | (1) | | | | | | | | | | | |
| | Phosphate | Phosphate | 6.75 | 7.20 | 6.75 | 7.20 | 6.00 | 6.00 | 6.00 | 4.50 | 7.50 | 7.50 | 7.50 |
| | compound | compound (1) | | | | | | | | | | | |
| | Silane coupling | Silane | 4.50 | 4.80 | 4.50 | 4.80 | 4.00 | 4.00 | 4.00 | 3.00 | 5.00 | 5.00 | 5.00 |
| | agent | coupling | | | | | | | | | | | |
| | | agent (1) | | | | | | | | | | | |
| (Meth) acrylate | Monofunctional | Compound | | | | | 43.58 | 48.58 | 38.58 | 51.08 | | | |
| compound (B) | (meth) acrylate | (B1-1) | | | | | | | | | | | |
| (parts by mass) | compound (B1) | Compound | 37.25 | 16.75 | 42.25 | 19.25 | | | | | | | |
| | | (B1-2) | | | | | | | | | | | |
| | | Compound | | 16.75 | | 19.25 | | | | | | | 36.00 |
| | | (B1-3) | | | | | | | | | | | |
| | | Compound | | | | | | | | | | | |
| | | (B1-4) | | | | | | | | | | | |
| | | Compound | | | | | | | | | 36.00 | | |
| | | (B1-5) | | | | | | | | | | | |
| | | Compound | | | | | | | | | | 36.00 | |
| | | (B1-6) | | | | | | | | | | | |
| | Polyfunctional | Compound | 5.00 | 5.00 | | | 5.00 | | 10.00 | 10.00 | | | |
| | (meth) acrylate | (B2-1) | | | | | | | | | | | |
| | compound (B2) | | | | | | | | | | | | |
| Photopolymerization initiator | | | 1.50 | 1.50 | 1.50 | 1.50 | 1.42 | 1.42 | 1.42 | 1.42 | 1.50 | 1.50 | 1.50 |
| [symbol] omposition | [(A)/(B1)] (mass ratio) | | 1.21 | 1.43 | 1.07 | 1.25 | 0.92 | 0.82 | 1.04 | 0.59 | 1.39 | 1.39 | 1.39 |
| ratio | [(B1)/(B)] (% by mass) | | 88.2 | 87.0 | 100.0 | 100.0 | 89.7 | 100.0 | 79.4 | 83.6 | 100.0 | 100.0 | 100.0 |
| | [Compound containing compound | | 100.0 | 100.0 | 100.0 | 100.0 | 100.0 | 100.0 | 100.0 | 100.0 | 0.0 | 0.0 | 100.0 |
| | containing two aromatic rings | | | | | | | | | | | | |
| | in one molecule/(B1)] | | | | | | | | | | | | |
| | (% by mass) | | | | | | | | | | | | |
| Evaluation of | Liquid refractive index | | 1.64 | 1.64 | 1.65 | 1.65 | 1.63 | 1.63 | 1.62 | 1.60 | 1.61 | 1.62 | 1.65 |
| composition | Viscosity (mPa•s) | | 400 | 900 | 400 | 900 | 500 | 800 | 1200 | 500 | 300 | 100 | 1600 |
| Evaluation | Mold releasability | | ⊚ | ⊚ | ⊚ | ⊚ | ⊚ | ⊚ | ⊚ | ⊚ | ⊚ | ⊚ | ⊚ |
| of cured | Base material adhesion | | 100 | 100 | 100 | 100 | 100 | 100 | 100 | 100 | 100 | 35 | 6 |
| product | Film refractive index | | 1.67 | 1.67 | 1.68 | 1.68 | 1.66 | 1.67 | 1.65 | 1.64 | 1.65 | 1.65 | 1.68 |
| | | | | Example | | | Comparative Example | | | | | | |
| | | | | 12 | 13 | 14 | 1 | 2 | 3 | 4 | 5 | 6 | |
| | Active energy ray curable composition No. | | | P12 | P13 | P14 | CP1 | CP2 | CP3 | CP4 | CP5 | CP 6 | |
| | Inorganic | Inorganic | Inorganic | 50.00 | 50.00 | 30.00 | 30.00 | 30.00 | 20.00 | 10.00 | 20.00 | | |
| | nanoparticles | nanoparticles | nanoparticles | | | | | | | | | | |
| | dispersion | (A) | (1) | | | | | | | | | | |
| | (parts by mass) | | | | | | | | | | | | |
| | | Phosphate | Phosphate | 7.50 | 10.00 | 4.50 | 4.50 | 4.50 | 3.00 | 1.50 | 3.00 | 15.00 | |
| | | compound | compound (1) | | | | | | | | | | |
| | | Silane coupling | Silane | 5.00 | 7.50 | 3.00 | 3.00 | 3.00 | 2.00 | 1.00 | 2.00 | 10.00 | |
| | | agent | coupling | | | | | | | | | | |
| | | | agent (1) | | | | | | | | | | |
| | (Meth) acrylate | Monofunctional | Compound | | | 56.08 | | 61.08 | 73.58 | 76.08 | 68.58 | 72.15 | |
| | compound (B) | (meth) acrylate | (B1-1) | | | | | | | | | | |
| | (parts by mass) | compound (B1) | Compound | | | | 61.08 | | | | | | |
| | | | (B1-2) | | | | | | | | | | |
| | | | Compound | 31.00 | | | | | | | | | |
| | | | (B1-3) | | | | | | | | | | |
| | | | Compound | | 31.00 | | | | | | | | |
| | | | (B1-4) | | | | | | | | | | |
| | | | Compound | | | | | | | | | | |
| | | | (B1-5) | | | | | | | | | | |
| | | | Compound | | | | | | | | | | |
| | | | (B1-6) | | | | | | | | | | |
| | | Polyfunctional | Compound | 5.00 | | 5.00 | | | | 10.00 | 5.00 | | |
| | | (meth) acrylate | (B2-1) | | | | | | | | | | |
| | | compound (B2) | | | | | | | | | | | |

| Photopolymerization initiator | | 1.50 | 1.50 | 1.42 | 1.42 | 1.42 | 1.42 | 1.42 | 1.42 | 2.85 |
|---|---|---|---|---|---|---|---|---|---|---|
| [symbol] omposition | [(A)/(B1)] (mass ratio) | 1.61 | 1.61 | 0.53 | 0.49 | 0.49 | 0.27 | 0.13 | 0.29 | 0.00 |
| ratio | [(B1)/(B)] (% by mass) | 86.1 | 100.0 | 91.8 | 100.0 | 100.0 | 100.0 | 88.4 | 93.2 | 100.0 |
| | [Compound containing compound | 100.0 | 100.0 | 100.0 | 100.0 | 100.0 | 100.0 | 100.0 | 100.0 | 100.0 |
| | containing two aromatic rings | | | | | | | | | |
| | in one molecule/(B1)] | | | | | | | | | |
| | (% by mass) | | | | | | | | | |
| Evaluation of | Liquid refractive index | 1.64 | 1.66 | 1.61 | 1.62 | 1.62 | 1.60 | 1.58 | 1.59 | 1.55 |
| composition | Viscosity (mPa•s) | 1600 | 2600 | 400 | 100 | 400 | 200 | 200 | 300 | 100 |
| Evaluation | Mold releasability | ⊚ | ⊚ | 0 | X | X | X | X | X | X |
| of cured | Base material adhesion | 100 | 100 | 100 | | | | | | |
| product | Film refractive index | 1.68 | 1.69 | 1.64 | 1.66 | 1.65 | 1.63 | 1.61 | 1.62 | 1.58 |

[symbol]

indicates data missing or illegible when filed

In the table, the meaning of each description is as follows:

The compositions of Comparative Examples 1 to 6 had bad mold releasability and could not produce prism sheets, so the adhesion test could not be conducted (measurement was impossible).

[(A)/(B1)]: the mass blending ratio of the monofunctional (meth)acrylate (B1) to the inorganic nanoparticles (A)

[(B1)/(B)]: the content of the monofunctional (meth)acrylate (B1) in the (meth)acrylate compound (B) (unit: % by mass)

[Compound containing compound containing two aromatic rings in one molecule/(B)]: the content of the compound containing the compound containing two aromatic rings in one molecule in the (meth)acrylate compound (B) (unit: % by mass)

Inorganic nanoparticle (A) (1): zirconia, trade name: UEP-100 (manufactured by Daiichi Kigenso Kagaku Kogyo Co., Ltd.)

Phosphate compound (1): Dispersant D-1, the compound represented by Structural Formula (1) above, Silane coupling agent (E) (1): 3-(trimethoxysilyl)propyl methacrylate, trade name: KBM-503 (manufactured by Shin-Etsu Chemical Co., Ltd.)

Compound (B1-1): ortho-phenylphenol (EO) acrylate, trade name: KOMERATE A011 (manufactured by Green Chemical Co., Ltd.)

Compound (B1-2): biphenylmethyl acrylate, trade name: MIRAMER M1192 (manufactured by Miwon Specialty Chemical Co., Ltd.)

Compound (B1-3): 3-phenoxybenzyl acrylate, trade name: KOMERATE A008 manufactured by Green Chemical Co., Ltd.)

Compound (B1-4): (1-naphthyl)methyl acrylate, trade name: Light Acrylate NMT-A (manufactured by Kyoeisha Chemical Co., Ltd.)

Compound (B1-5): phenoxyethyl acrylate, trade name: Photomer 4035 (manufactured by IGM Resins Inc.)

Compound (B1-6): benzyl acrylate, trade name: MIRAMER M1182 (manufactured by Miwon Specialty Chemical Co., Ltd.)

Compound (B2-1): a mixture of pentaerythritol triacrylate and pentaerythritol tetraacrylate (containing about 60% of the tri-body), trade name: Aronix M305 (manufactured by Toagosei Co., Ltd.)

Photopolymerization initiator (C): 2,4,6-trimethylbenzoyl diphenylphosphine oxide, trade name: Runtecure 1108 (manufactured by Runtec Chemical Co., Ltd.)

### DISCUSSION

As listed in Table 1, it was confirmed that Examples 1 to 14, in which the content of the monofunctional (meth)acrylate (B1) in the (meth)acrylate compound (B) was 70% by mass or more, and the mass blending ratio [(A)/(B1)] of the monofunctional (meth)acrylate (B1) to the inorganic nanoparticles (A) was in a range of 0.5 to 3, had a high refractive index and a low viscosity in the compositions and had good mold releasability and had a high film refractive index in the cured products.

It was confirmed that among them Examples 1 to 9 and 12 to 14, in which at least any of Compound (B1-1) (ortho-phenylphenol (EO) acrylate), Compound (B1-2) (biphenylmethyl acrylate), Compound (B1-4) ((1-naphthyl)methyl acrylate), Compound (B1-5) (phenoxyethyl acrylate), and Compound (B2-1) (pentaerythritol triacrylate (containing pentaerythritol tetraacrylate) was used as the (meth)acrylate compound (B), had better base material adhesion.

Furthermore, Examples 11 to 13, in which the compound containing two aromatic rings in one molecule was used as the monofunctional (meth)acrylate (B1), improved in the refractive index compared to Examples 9 and 10, in which the compound not containing two aromatic rings in one molecule was used as the monofunctional (meth)acrylate (B1). On the other hand, in Comparative Examples 1 to 5, in which the mass blending ratio [(A)/(B1)] of the monofunctional (meth)acrylate (B1) to the inorganic nanoparticles (A) was less than 0.5, the cured products had poor mold releasability, and prism sheets could not be produced.

In Comparative Example 6, which did not contain the inorganic nanoparticles (A), the refractive index was significantly poor, and good mold releasability could not be obtained.

1. An active energy ray-curable composition comprising:
inorganic nanoparticles (A);
a (meth)acrylate compound (B); and
a photopolymerization initiator (C),
the (meth)acrylate compound (B) containing a monofunctional (meth)acrylate (B1),
a content of the monofunctional (meth)acrylate (B1) in the (meth)acrylate compound (B) being 70% by mass or more, and
a mass blending ratio [(A)/(B1)] of the monofunctional (meth)acrylate (B1) to the inorganic nanoparticles (A) being in a range of 0.5 to 3.

2. The active energy ray-curable composition according to claim 1, wherein a content of the inorganic nanoparticles (A) in the active energy ray-curable composition is 30% by mass or more.

3. The active energy ray-curable composition according to claim 1, wherein the inorganic nanoparticles (A) are one or more selected from the group consisting of zirconia, silica, barium sulfate, zinc oxide, barium titanate, cerium oxide, and alumina and titanium oxide.

4. The active energy ray-curable composition according to claim 1, wherein
the (meth)acrylate compound (B) further contains a polyfunctional (meth)acrylate (B2),
a content of the monofunctional (meth)acrylate (B1) in the (meth)acrylate compound (B) is in a range of 70 to 90% by mass, and
a content of the polyfunctional (meth)acrylate (B2) in the (meth)acrylate compound (B) is in a range of 10 to 30% by mass.

5. The active energy ray-curable composition according to claim 1, wherein the monofunctional (meth)acrylate (B1) contains a compound containing two aromatic rings in one molecule.

6. The active energy ray-curable composition according to claim 5, wherein a content of the compound containing two aromatic rings in one molecule in the monofunctional (meth)acrylate (B1) is 50% by mass or more.

7. The active energy ray-curable composition according to claim 1, further comprising a dispersant (D), wherein
the dispersant (D) contains a phosphate compound, and
the phosphate compound has at least one (meth)acryloyl group and at least one polyester chain.

8. The active energy ray-curable composition according to claim 1, wherein the active energy ray-curable composition has a viscosity at 25° C. of 1,200 mPa·s or less.

9. A cured product of the active energy ray-curable composition according to claim 1.

10. The cured product according to claim 9, wherein the cured product has a refractive index (589 nm) at 25° C. of 1.65 or more.

11. An optical sheet comprising the cured product according to claim 9.

12. An optical sheet comprising the cured product according to claim 10.

13. The active energy ray-curable composition according to claim 2, wherein the inorganic nanoparticles (A) are one or more selected from the group consisting of zirconia, silica, barium sulfate, zinc oxide, barium titanate, cerium oxide, and alumina and titanium oxide.

14. The active energy ray-curable composition according to claim 2, wherein
the (meth)acrylate compound (B) further contains a polyfunctional (meth)acrylate (B2),
a content of the monofunctional (meth)acrylate (B1) in the (meth)acrylate compound (B) is in a range of 70 to 90% by mass, and
a content of the polyfunctional (meth)acrylate (B2) in the (meth)acrylate compound (B) is in a range of 10 to 30% by mass.

15. The active energy ray-curable composition according to claim 2, wherein the monofunctional (meth)acrylate (B1) contains a compound containing two aromatic rings in one molecule.

16. The active energy ray-curable composition according to claim 15, wherein a content of the compound containing two aromatic rings in one molecule in the monofunctional (meth)acrylate (B1) is 50% by mass or more.

17. The active energy ray-curable composition according to claim 2, further comprising a dispersant (D), wherein
the dispersant (D) contains a phosphate compound, and
the phosphate compound has at least one (meth)acryloyl group and at least one polyester chain.

18. The active energy ray-curable composition according to claim 2, wherein the active energy ray-curable composition has a viscosity at 25° C. of 1,200 mPa·s or less.

19. A cured product of the active energy ray-curable composition according to claim 2.

20. The cured product according to claim 19, wherein the cured product has a refractive index (589 nm) at 25° C. of 1.65 or more.
